(19) United States
(12) Patent Application Publication
(10) Pub. No.: US 2017/0061407 A1
(43) Pub. Date: Mar. 2, 2017

(54) APPARATUS FOR MANAGING ATM FAILURE, USER TERMINAL INTERWORKING WITH SAME, AND METHOD FOR MANAGING ATM FAILURE

(71) Applicant: Nautilus Hyosung Inc., Seoul (KR)

(72) Inventor: Jason KUHN, Mount Eden, KY (US)

(21) Appl. No.: 15/016,826

(22) Filed: Feb. 5, 2016

(30) Foreign Application Priority Data
Aug. 27, 2015 (KR) 10-2015-0120859

(51) Int. Cl. G06Q 20/10; G06Q 10/00; H04W 4/00

(52) U.S. Cl. CPC G06Q 20/1085; H04W 4/008; G06Q 10/20; H04W 88/02

(57) ABSTRACT

In accordance with the present invention, there is provided a failure management apparatus. The failure management apparatus includes a processor configured to detect a failure in an ATM (Automated Teller Machine) and create state information for the ATM, including information about the failure and a communication unit configured to send the state information to a user terminal connected with a management server for managing a state of the ATM via a network.

### FIELD OF THE INVENTION

The present invention relates to an apparatus for managing ATM (Automated Teller Machine) failures, a user terminal interworking with the apparatus, and a method for managing the ATM failures, and more particularly to an apparatus, a user terminal and a method for more efficiently managing an ATM by sending information about the state of the ATM to a management server for managing the ATM failures.

### BACKGROUND OF THE INVENTION

ATMs (Automatic Teller Machines) have innovatively developed conventional financial transactions carried out by tellers in a bank. For example, an ATM reduces customer's waiting time, and enables customers to be provided with financial transactions after business hours of a financial institution. In addition, financial service transaction times reduced by the ATM enable a financial institution to achieve efficiency in terms of human resources and costs. As described above, ATMs are installed in financial institutions, for example, banks or village fund, to provide financial transaction services, and placed anywhere frequented by a large number of people now.

Meanwhile, an ATM may fail. It is thus essential to fix the failure as soon as possible to ensure safe financial transactions through the ATM. A conventional method for fixing ATM failures is to place a telephone near the ATM or provide contact information of a person in charge of the ATM. An ATM user uses the phone or contact information to contact the person in charge of the ATM to notify the person of an ATM failure, and the person in charge may describe a solution for fixing the ATM failure over the phone or visit the site to fix the ATM failure. The user may be a customer who uses the ATM for financial transactions, a bank staff member operating the ATM, and a person who installs and operates general-purpose ATMs in shops, for example, a convenience store owner.

By the way, the person in charge may not fully understand what a user explains about the ATM failure over the phone. In addition, the user may not fully understand a solution the person in charge explains over the phone. This contributes to making the person in charge visit the site concerned although an insignificant failure occurs. This is not effective in terms of time and costs.

In relation to the aforementioned issues, U.S. Patent Application Publication No. 2015/0066761 (a patent document 1) discloses a method for providing users with information about how to use services through video communication with a customer service staff member, and U.S. Pat. No. 7,545,816 (a patent document 2) discloses a method for enabling a terminal used for providing financial services to communicate with a management server for managing at least one terminal through a program sent by the management server so that the terminal may be managed by the server. However, users also may fail to explain exact details of the ATM failure through the video communication with a customer service staff member in the patent document 1. In the patent document 2, it is difficult to fix a failure as soon as a user finds the failure, and it is not easy to fix the failure if a wired communication network for communication with the server has a problem.

Therefore, there is a need for a new technology that a user explains exact details of an ATM failure to a person in charge to enable the person in charge to take best measures for the failure, a user-friendly solution for minor failures is provided to the user to fix the minor failures, thereby fixing failures fast and avoiding making unnecessary efforts by the person in charge, and users take measures against failures through user terminals although a wired communication network linked with an ATM concerned does not normally work.

### SUMMARY OF THE INVENTION

In view of the above, the present invention provides an apparatus, a user terminal, and a method for sending exact details of ATM failures to a person in charge of the ATM, and rapidly fixing the failures without wasting time and costs.

Further, the present invention provides an apparatus, a user terminal, and a method for fixing failures in ATMs independently of the state of a wired communication network linked with the ATMs.

The object of the present invention is not limited to those mentioned above, and the present invention may have other objects that will be apparently understood to those skilled in the art from the following description although they are not described above in detail.

In accordance with the present invention, there is provided a failure management apparatus including a processor configured to detect a failure in an ATM (Automated Teller Machine) and create state information for the ATM, including information about the failure and a communication unit configured to send the state information to a user terminal connected with a management server for managing a state of the ATM via a network.

Further, the state information may further include information about a solution for fixing the failure or a link through which the information about the solution is accessible.

Further, the state information may further include contact information about a person in charge of managing the ATM.

Further, the failure management apparatus may further include a log recording unit configured to store details of transactions or failures in the ATM, wherein, in respond to a request of the user terminal, the communication unit is configured to send the details of transactions or failures in the ATM to the user terminal.

Further, the communication unit may be configured to send the state information to the user terminal by using a QR (Quick Response) code or through NFC (Near Field Communication).

In accordance with the present invention, there is provided a user terminal including a terminal communication unit configured to receive state information for an ATM (Automated Teller Machine) from a failure management apparatus configured to manage ATM failures, and send the state information to a management server configured to manage the state of the ATM, a terminal control unit configured to create converts the state information into user-recognizable state information, and an output unit configured to output the user-recognizable state information, wherein the state information includes information about failures detected in the ATM.

Further, the state information may further include information about a solution for fixing the failures or a link through which the information about the solution is accessible.

Further, the state information may further include contact information about a person in charge of managing the ATM.

Further, the state information may further include details of transactions or failures in the ATM.

Further, the terminal communication unit may receive the state information from the failure management apparatus by using a QR (Quick Response) code or through NFC (Near Field Communication).

In accordance with the present invention, there is provided a method for managing failures carried out in the failure management apparatus including detecting the failure of the ATM, creating the state information for the ATM including information about the failure, and sending the state information to the user terminal connected with the management server configured to manage the state of the ATM via a network.

Further, the state information may further include information about a solution for fixing the failure or a link through which the information about the solution is accessible.

Further, the state information may further include contact information about a person in charge of managing the ATM.

Further, the method may further include storing details of transactions or failures in the ATM, in a log recording unit, wherein, in respond to a request of the user terminal, the details of transactions or failures in the ATM are sent to the user terminal.

Further, the state information may be sent to the user terminal by using a QR (Quick Response) code or through NFC (Near Field Communication).

In accordance with the present invention, there is provided a method for managing failures carried out in the user terminal including receiving the state information from the failure management apparatus, converting the state information into the user-recognizable state information, outputting the user-recognizable state information, and sending the state information to the management server configured to manage the state of the ATM, wherein the state information further includes the information about failures detected in the ATM.

Further, the state information may further include information about a solution for fixing the failures or a link through which the information about the solution is accessible.

Further, the state information may further include contact information about a person in charge of managing the ATM.

Further, the state information may further include details of transactions or failures in the ATM.

Further, the state information may be received from the failure management apparatus by using a QR (Quick Response) code or through NFC (Near Field Communication).

As set forth above, in accordance with the embodiments of the present invention, a failure management system and method may be provided for detecting and analyzing ATM failures, sending details of the failures to a management server for managing ATM failures, and sending information about a solution for minor failures needed to fix them by a terminal user to a user terminal.

Accordingly, it is possible to send exact details of an ATM failure to a person in charge to suggest a best solution for the failure situation, and guide a user to enable the user to fix minor failures in a user-friendly manner, rapidly fix problems and avoid making unnecessary efforts by the person in charge. In addition, although a wired communication network linked with the ATM does not normally work, measures may be taken against failures through a user terminal.

### BRIEF DESCRIPTION OF THE DRAWINGS

FIG. 1 shows a configuration of a failure management system in accordance with an embodiment of the present invention;

FIG. 2 shows a configuration of a failure management apparatus in accordance with an embodiment of the present invention;

FIG. 3 shows a configuration of a user terminal in accordance with an embodiment of the present invention;

FIG. 4 shows a flow diagram illustrating a method for managing failures carried out in a failure management apparatus in accordance with an embodiment of the present invention; and

FIG. 5 shows a flow diagram illustrating a method for managing failures carried out in a user terminal in accordance with an embodiment of the present invention.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions and/or constitutions will not be described in detail if they would unnecessarily obscure the features of the present invention in unnecessary detail. Further, the terms to be described below are defined in consideration of their functions in the embodiments of the present invention and may vary depending on a user's or operator's intention or practice. Accordingly, the definition may be made on a basis of the content throughout the specification.

Hereinafter, the embodiments of the present invention will be described in detail with reference to the accompanying drawings.

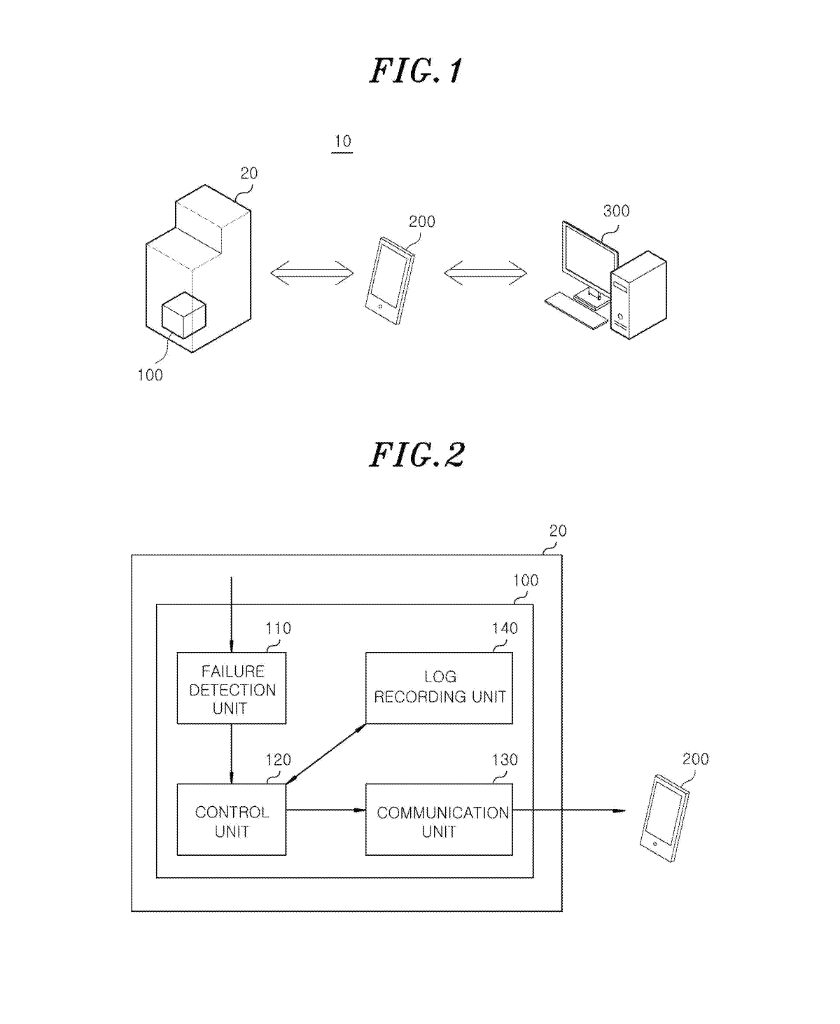

FIG. 1 shows a configuration of a failure management system in accordance with an embodiment of the present invention. The failure management system 10 may include an ATM 20, a failure management apparatus 100, a user terminal 200, and a management server 300. However, since the failure management system 10 shown in FIG. 1 is just an embodiment of the present invention, it should be noted that the present invention is not limited to the system shown in FIG. 1.

The ATM 20 is a device used to enable users to carry out financial transactions without visiting tellers in a bank. The failure management apparatus 100 is a device used for detecting failures of the ATM 20 and sending information about the state of the ATM, i.e. state information for the ATM, including information about detected failures to the user terminal 200 owned by a user to efficiently fix the failures. The failure management apparatus 100 may be implemented as part of the ATM 20 as shown in FIG. 1, and may be implemented external to the ATM 20, unlike FIG. 1. As used herein, exemplary ATM users may include a customer who uses the ATM for financial transactions, a person in charge of operating the ATM, and a person who installs and operates general ATMs in shops, for example, a convenience shop owner.

The user terminal 200 may receive information about the state of the ATM 20 from the failure management apparatus 100, transfer it to the management server 300 or notify the user of the information about a method for fixing failures. The user terminal 200 may be a wireless handheld communication device usually portable and movable, for example, a PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (Wideband Code Division Multiple Access), Wibro (Wireless Broadband Internet) terminal, smartphone, Smartpad, and tablet PC, but is not limited thereto. The user terminal 200 is linked with the management server 300 through a wired or wireless network, and the exemplary wireless network link may be implemented through Wi-Fi, 3G (Third Generation), 4G (Fourth Generation), LTE (Long term Evolution), ZigBee, or Bluetooth.

The management server 300 may be responsible for receiving information about the state of the ATM 20 from the user terminal 200 to manage the state of the ATM 20. The management server 300 may be a computer, for example, a PC (personal computer) or server.

In addition, the management server 300 may also manage the state of a plurality of ATMs 20. In this case, the management server 300 may manage each of the ATMs 20 although the ATMs 20 are manufactured by different manufacturers, respectively.

Meanwhile, although not shown in FIG. 1, the ATM 20 may be linked with a server of a financial institution to perform financial transactions, but this is apparent to those skilled in the art, and thus not described in detail herein.

FIG. 2 shows a configuration of a failure management apparatus in accordance with an embodiment of the present invention. As shown in FIG. 2, the failure management apparatus 100 may include a failure detection unit 110, a control unit 120 and a communication unit 130. The failure management apparatus 100 and each component of the failure management apparatus 100 may be implemented in a computing device including a microprocessor.

The failure detection unit 110 may detect failures of the ATM 20. The failures of the ATM 20 refer to the state that the ATM 20 does not normally operate and a user may not be provided with normal financial services, and may include both hardware and software failures.

The control unit 120 may create information about the state of the ATM 20 wherein the information about the state thereof may include information about the failures of the ATM 20 detected by the failure detection unit 110. Specifically, the information about the state of the ATM 20 may include unique information, for example, a unique number for identifying the ATM 20, time when a failure concerned occurred, a failure code or details of the failure. The failure detection unit 110 and the control unit 120 may be implemented using a microprocessor.

The communication unit 130 may send the information about the state of the ATM 20 created by the control unit 120 to the user terminal 200. To this end, the communication unit 130 may include a communication module, such as a LAN card, a Bluetooth module, or an NFC module, for sending and receiving data to/from the user terminal 200.

Operation of the failure management apparatus 100 configured as described above in accordance with the present embodiment will be described hereinafter with reference to FIG. 2.

If the ATM 20 fails, the failure detection unit 110 may detect the failure, and the control unit 120 may create information about the state of the ATM 20 including information about the failure detected by the failure detection unit 110. The created information about the state of the ATM 20 may be sent to the user terminal 200 by means of the communication unit 130.

In addition, the information about the state of the ATM 20 may include information about a solution for fixing a failure or a link to be connected with information about the solution in a specific case. The aforementioned specific case refers to the case that, for example, a failure that occurred may minor failure that may be fixed by a user without intervention of a person in charge of the ATM 20, and may be categorized as a typical type of failure. Such a categorization may be carried out in conformity with criteria defined in advance. The information about the solution provided for fixing the failure may be of a type of text, voice, image or video, and from a database built in advance. The database built in advance may be implemented as a computer-readable recording medium embedded in or external to the failure management apparatus. Exemplary computer-readable recording media may include magnetic media such as a hard disk, floppy disk and magnetic tape, optical media such as a CD-ROM and DVD, magneto-optical media such as a floptical disk, and hardware devices configured to store and execute program instructions such as a ROM, RAM and flash memory. In accordance with the present embodiment, since minor failures of the ATM 20 may be rapidly fixed by a user without waiting for help by a person in charge of the ATM 20, time and efforts for the help may be saved.

Further, the information about the state of the ATM 20 may include contact information about the person in charge of the ATM. The contact information may be displayed on the screen of the user terminal 200, and the user may contact the person in charge to fix the failure if the failure is not fixed although a solution for fixing the failure is provided.

The communication unit 130 may send the information about the state of the ATM 20 to the user terminal 200 through NFC (Near Field Communication). In addition, in accordance with another embodiment of the present invention, the information about the state of the ATM may be sent by using a barcode, for example, a QR (Quick Response) code. To do it, the communication unit 130 may process the information about the state of the ATM created by the control unit 120 to create a barcode such as a QR code, and the user terminal 200 may receive the information about the state of the ATM by reading the barcode.

Furthermore, the failure management apparatus 100 may further include a log recording unit 140 for storing details of transactions or failures of the ATM 20. The details of transactions may include time of individual transactions, transaction accounts, details of deposits and withdrawals, available fund in ATM after the transactions. The details of failures may include time of individual failures in the ATM 20, types and contents of the failures, solutions provided and the result of provided solutions. The log recording unit 140 may be implemented specifically as a computer-readable recording medium. Since an exemplary computer-readable recording medium is the same as a database built in advance for storing information about solutions for fixing the failures, it is not described herein in more detail. In the present embodiment, the communication unit 130 may be configured to send the aforementioned details of transactions or failures to the user terminal 200 to respond to a request of the user terminal 200. In this configuration, it is possible to make sending the details of transactions or failures enabled, provided that an authentication process, for example, by using an authentication code established in advance is successful. Exemplary authentication may be carried out by making the user of the user terminal 200 pass the authentication process, provided that the user is a bank staff member, not an ordinary customer.

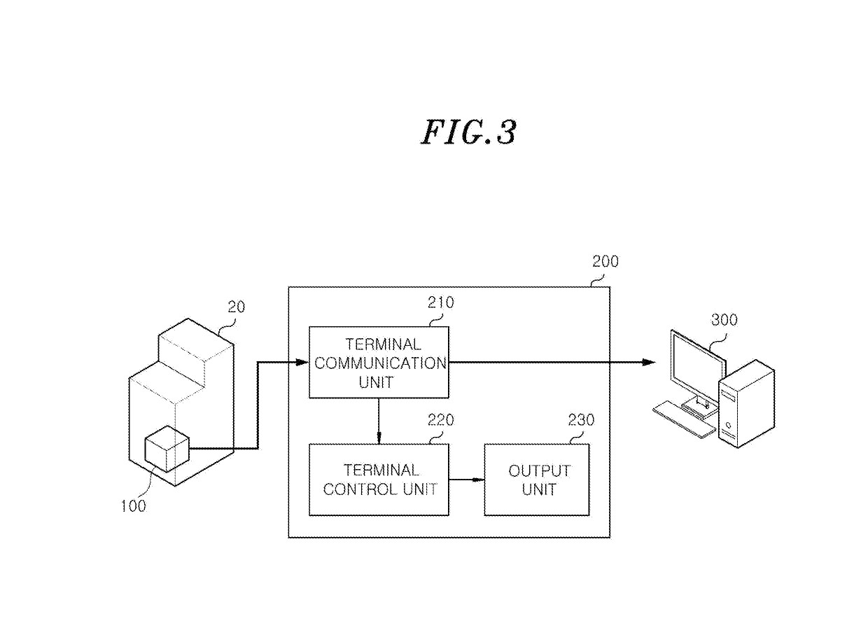

FIG. 3 shows a configuration of a user terminal in accordance with an embodiment of the present invention. Referring to FIG. 3, the user terminal 200 may include a terminal communication unit 210, a terminal control unit 220 and an output unit 230 wherein each component of the user terminal 200 may be implemented with a computing device including a microprocessor.

The terminal communication unit 210, which is capable of sending and receiving information, may receive information about the state of the ATM 20 from the failure management apparatus 100 and send the information about the state of the ATM 20 to the management server 300 for managing the state of the ATM 20. Accordingly, the terminal communication unit 210 may include a communication module, such as a LAN card, a Bluetooth module, or an NFC module, for sending/receiving data to/from the failure management apparatus 100 and the management server 300.

The terminal control unit 220 may create converted information about the state of the ATM to enable the user of the user terminal 200 to recognize it on the basis of the information about the state of the ATM 20 received by the terminal communication unit 210. The converted information about the state of the ATM, i.e. the user-recognizable state information, may be of the type of text, voice, image or video. The terminal control unit 220 may be implemented using a microprocessor.

The output unit 230 may output the converted information about the state of the ATM created by the terminal control unit 220. Such an output unit 230 may include a display device, for example, an LCD (Liquid Crystal Display) or OLED (Organic Light Emitting Diode) and a loudspeaker, depending on the nature of information about the state of the ATM.

The operation of the user terminal 200 configured as described above in accordance with the present embodiment will be described hereinafter with reference to FIG. 3. The same description as provided with reference to FIG. 2 may not be provided again.

The information about the state of the ATM 20 sent by the failure management apparatus 100 for managing the ATM is received by the terminal communication unit 210. The information may include information about failures detected in the ATM 20. The terminal control unit 220 may create converted information about the state of the ATM which can be recognized by the user on the basis of the information about the state of the ATM received by the terminal communication unit 210. The converted information about the state of the ATM may be outputted by the output unit 230 to enable the user to recognize it, and the terminal communication unit 210 may send the converted information about the state of the ATM to the management server 300. Through the above mentioned process, the person in charge of managing the ATM 20, for example, maintaining and fixing the ATM 20, may know details of the failure that occurred in the ATM 20 through the management server 300, and thus take appropriate effective measures based on the details. Moreover, although the wired communication network linked with the ATM 20 does not normally work, measures may be taken against failures through the user terminal.

In addition, the information about the state of the ATM may include contact information about the person in charge of managing the ATM. The contact information may be displayed through the output unit 230. Therefore, if the user is not able to fix the failure although a solution for fixing the failure is provided, the user may contact the person in charge to fix the failure.

In addition, the information about the state of the ATM may include information about a solution for fixing a failure or a link to be connected with the information about the solution in a specific case. In accordance with the present embodiment, since minor failures of the ATM 20 may be rapidly fixed without waiting for help provided by the person in charge, time and efforts for help by the person in charge are not necessary.

Further, the information about the state of the ATM 20 may include details of transactions or failures in the ATM stored in the log recording unit 140 of the failure management apparatus 100.

Furthermore, the terminal communication unit 210 may receive the information about the state of the ATM 20 from the failure management apparatus 100 through NFC (Near Field Communication). In addition, in accordance with another embodiment of the present invention, the information about the state of the ATM may be sent by using a barcode, for example, a QR code. Then, the terminal communication unit 210 may read the barcode, for example, a QR code, including the information about the state of the ATM 20 to obtain the information about the state of the ATM.

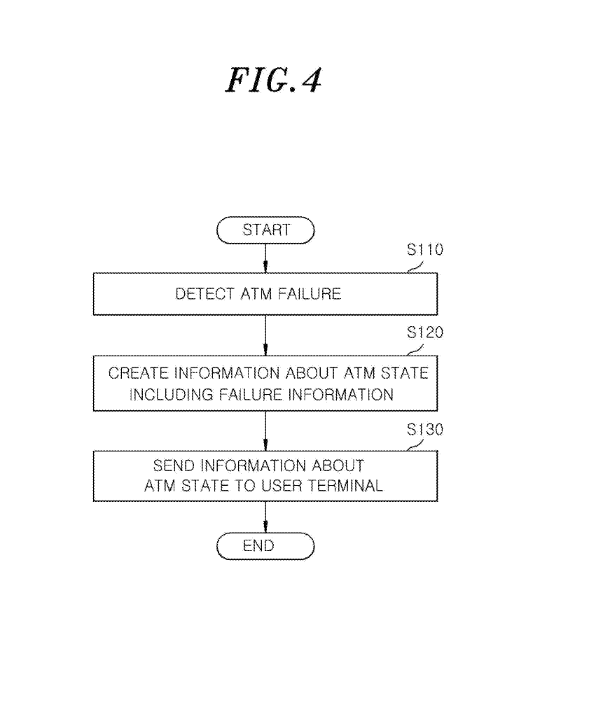

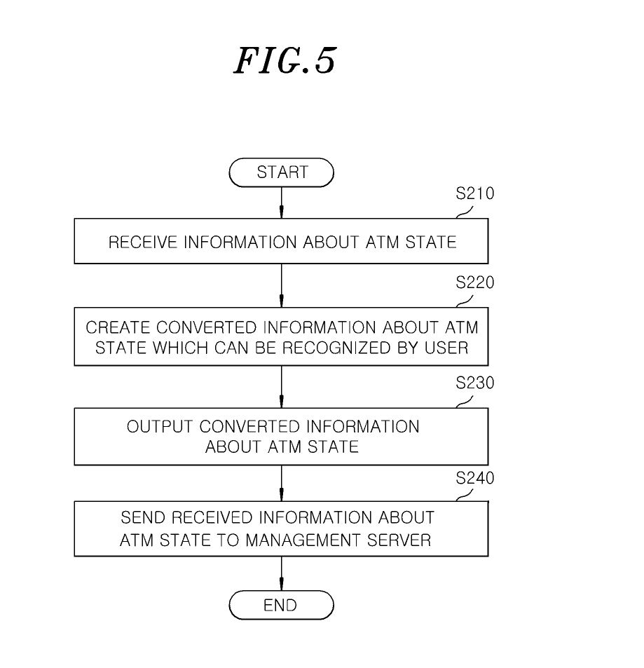

FIG. 4 shows a flow diagram illustrating a method for managing failures carried out in a failure management apparatus in accordance with an embodiment of the present invention. Referring to FIG. 4, each operation of the method for managing failures carried out in the failure management apparatus will be described below.

If an ATM fails, the failure of the ATM is first detected at operation S110. Next, information about the state of the ATM including the information about the detected failure is created at operation S120. The created information about the state of the ATM is sent to the user terminal linked with the management server for managing the ATM state at operation S130.

For example, the information about the state of the ATM may be sent to the user terminal through NFC (Near Field Communication) or by using a barcode, for example, a QR code.

The information about the state of the ATM may include information about a solution for fixing the failure or a link to be connected with information about the solution. In addition, the information about the state of the ATM may include contact information about a person in charge of managing the ATM. In addition, the information about the state of the ATM may include information about details of transactions or failures in the ATM.

FIG. 5 shows a flow diagram illustrating a method for managing failures carried out in a user terminal in accordance with an embodiment of the present invention. Referring to FIG. 5, each operation of the method for managing failures carried out in the user terminal will be described below.

The information about the state of the ATM including information about a failure detected in the ATM is received at operation S210, and converted information about the state of the ATM which can be recognized by a user is created on the basis of the received information about the state of the ATM at operation S220. Next, the converted information about the state of the ATM is outputted at operation S230, and the received converted information about the state of the ATM is sent to the management server for managing the state of the ATM at operation S240.

For example, the information about the state of the ATM may be sent to the user terminal through NFC (Near Field Communication) or by using a barcode, for example, a QR code.

In addition, the information about the state of the ATM may include contact information about a person in charge of managing the ATM. In addition, the information about the state of the ATM may include information about a solution for fixing the failure or a link to be connected with information about the solution. In addition, the information about the state of the ATM may include information about details of transactions or failures in the ATM.

Since the method for managing failures and the sequence of each operation of the method for managing failures carried out in the failure management apparatus for managing the ATM carried out in the user terminal are not limited to the sequence described above, the sequence of each operation may be changed and executed if required. The method for managing failures may be performed by a computing device including a microprocessor.

Embodiments of the present invention include computer-readable media including program instructions to implement various operations embodied by a computer. The computer-readable media may include, alone or in combination with the program instructions, data files, data structures, and the like. The computer-readable media and program instructions may be those specifically designed and constructed for adapting the embodiments of the present invention or those well-known and available to those skilled in the computer software art. Examples of the computer-readable media may include magnetic media such as a hard disk, floppy disk and magnetic tape, optical media such as a CD-ROM (Compact Disk-Read Only Memory) and DVD (Digital Versatile Disk), magneto-optical media such as a floptical disk, and hardware devices configured to store and execute program instructions such as a ROM, RAM and flash memory. Examples of the program instructions may include both higher level codes that may be executed by a computer using an interpreter, as well as machine codes such as produced by a compiler.

Features, structures, and effects described in the above embodiments are included in at least one embodiment of the present invention, but are not necessarily limited to one embodiment. In addition, features, structures, and effects illustrated in the respective embodiments may be carried out in combination or modification for other embodiments by those skilled in the art belonging to the embodiments. Therefore, those related to the combination and modification will have to be construed as being within the scope of the invention.

Further, while the description has been made with reference to the above mentioned embodiments, this is only illustrative and is not intended to limit the present invention, and those of ordinary skill in the art to which the invention pertains to the embodiments will appreciate that the various modifications and applications may be possible without departing from the principles of the embodiments. For example, the components that are specifically shown in the embodiments may be practiced through modifications thereof. And differences relating to these modifications and applications will have to be construed as being within the scope of the invention defined in the appended claims.

What is claimed is:

1. A failure management apparatus comprising:
a processor configured to detect a failure in an ATM (Automated Teller Machine) and create state information for the ATM, including information about the failure; and
a communication unit configured to send the state information to a user terminal connected with a management server for managing a state of the ATM via a network.

2. The failure management apparatus of claim 1, wherein the state information further includes information about a solution for fixing the failure or a link through which the information about the solution is accessible.

3. The failure management apparatus of claim 1, wherein the state information further includes contact information about a person in charge of managing the ATM.

4. The failure management apparatus of claim 1, further comprising a log recording unit configured to store details of transactions or failures in the ATM,
wherein, in respond to a request of the user terminal, the communication unit is configured to send the details of transactions or failures in the ATM to the user terminal.

5. The failure management apparatus of claim 1, wherein the communication unit is configured to send the state information to the user terminal by using a QR (Quick Response) code or through NFC (Near Field Communication).

6. A user terminal comprising:
a terminal communication unit configured to receive state information for an ATM (Automated Teller Machine) from a failure management apparatus configured to manage ATM failures, and send the state information to a management server configured to manage the state of the ATM;
a terminal control unit configured to create converts the state information into user-recognizable state information; and
an output unit configured to output the user-recognizable state information,
wherein the state information includes information about failures detected in the ATM.

7. The user terminal of claim 6, wherein the state information further includes information about a solution for fixing the failures or a link through which the information about the solution is accessible.

8. The user terminal of claim 6, wherein the state information further includes contact information about a person in charge of managing the ATM.

9. The user terminal of claim 6, wherein the state information further includes details of transactions or failures in the ATM.

10. The user terminal of claim 6, wherein the terminal communication unit receives the state information from the failure management apparatus by using a QR (Quick Response) code or through NFC (Near Field Communication).

11. A method for managing failures carried out in the failure management apparatus described in claim 1, the method comprising:
detecting the failure of the ATM;
creating the state information for the ATM including information about the failure; and
sending the state information to the user terminal connected with the management server configured to manage the state of the ATM via a network.

12. The method of claim 11, wherein the state information further includes information about a solution for fixing the failure or a link through which the information about the solution is accessible.

13. The method of claim 11, wherein the state information further includes contact information about a person in charge of managing the ATM.

14. The method of claim 11, further comprising storing details of transactions or failures in the ATM, in a log recording unit,
wherein, in respond to a request of the user terminal, the details of transactions or failures in the ATM are sent to the user terminal.

15. The method of claim 11, wherein the state information is sent to the user terminal by using a QR (Quick Response) code or through NFC (Near Field Communication).

16. A method for managing failures carried out in the user terminal described in claim 6, the method comprising:
receiving the state information from the failure management apparatus;
converting the state information into the user-recognizable state information;
outputting the user-recognizable state information; and
sending the state information to the management server configured to manage the state of the ATM,
wherein the state information further includes the information about failures detected in the ATM.

17. The method of claim 16, wherein the state information further includes information about a solution for fixing the failures or a link through which the information about the solution is accessible.

18. The method of claim 16, wherein the state information further includes contact information about a person in charge of managing the ATM.

19. The method of claim 16, wherein the state information further includes details of transactions or failures in the ATM.

20. The method of claim 16, wherein the state information is received from the failure management apparatus by using a QR (Quick Response) code or through NFC (Near Field Communication).
